(19) United States
(12) Patent Application Publication
(10) Pub. No.: US 2011/0107825 A1
(43) Pub. Date: May 12, 2011

(54) Anaerobic soil indicator device

(76) Inventor: Byron J. Jenkinson, West Lafayette, IN (US)

(21) Appl. No.: 12/590,722

(22) Filed: Nov. 12, 2009

(51) Int. Cl. G01N 5/02

(52) U.S. Cl. 73/73

(57) ABSTRACT

An indicator device is adapted to be disposed in the soil and is associated with an energy source for anaerobic microorganisms that is released into the soil in a manner to initiate anaerobic microbial activity in the soil in a manner that causes a change in color of the device over time. The color change on the device can be used to indicate the depth of the water table at the tested location.

### FIELD OF THE INVENTION

The invention relates to an indicator device and method useful for determining depth of the water table (the groundwater surface where the groundwater pressure is equal to atmospheric pressure) at a test location.

### BACKGROUND OF THE INVENTION

Natural wetlands collect and purify surface water before it reaches the streams and aquifers that provide our drinking water. They also serve as habitats for many birds and animals, and they provide areas for recreation. We have drained or developed most of the wetlands in the U.S. In recent years, however, Americans decided, through congressional action, to preserve our remaining wetlands. Because wetland cannot be drained or developed, there is much interest in whether or not a specific tract of land qualifies as a wetland. This device will help wetland delineators make that decision.

In 1987 the Army Corps. Of Engineers published the Wetland Delineation Manual in response to federal legislation mandating the protection of wetlands. Additional federal publications for identifying and delineating wetlands 59 FR 35680, Jul. 13, 1994, and 60 Fr 10349, Feb. 24, 1995 were published. According to the documents, wetlands cannot be drained or destroyed by development under penalty and or special mitigation requirements. Jurisdictional wetlands have three essential requirements: hydric soils, hydrophytic vegetation, and wetland hydrology. By definition, hydric soils are those that are saturated, flooded, or ponded long enough during the growing season to develop anaerobic conditions in the upper part. That is, hydric soils have a water table at or near surface for a time long enough during the growing season to become anaerobic. In saturated soils anaerobic microorganisms use compounds such as nitrate, manganese oxides and/or iron oxides as an electron acceptor instead of oxygen in respiration processes. A byproduct of this microbial activity is the increased mobility of Mn and Fe in the soil solution. The saturated conditions of the hydrology factor, the soil oxygen deficiency of the vegetation factor, and the anaerobic conditions of the soil factor are all related (Franzweier, D. P., E. J. Kladivko, and B J Jenkinson. 2001. Drainage and Wet Soil Management. Purdue University Cooperative Extension Service).

Jenkinson U.S. Pat. No. 6,766,762 issued Jul. 27, 2004, describes an indicator device and method for determining whether or not a soil is hydric.

An object of the invention is to provide an indicator device and method for determining the depth of the water table at a test location.

### SUMMARY OF THE INVENTION

The present invention provides an indicator device that is adapted to be disposed in the soil and is associated with an energy source for anaerobic microorganisms that is released into the soil in a manner to initiate anaerobic microbial activity after the soil becomes saturated in a manner that causes a change in color of the device over time. The depth of the water table (the groundwater surface at which the groundwater pressure is equal to atmospheric pressure) at a test location is indicated by the location of the color change on the device at the test site or location. The indicator device also can be used to indicate an anaerobic condition of a septic field at a test site or location.

In an illustrative embodiment of the invention, the indicator device comprises a tubular member and an energy source, such as agar/sugar solution, for anaerobic microorganisms disposed inside the tubular member for release to the soil through one or more openings therein to initiate anaerobic microbial activity in the soil. The device includes an indicator coating on the outside surface of the tubular member. The indicator coating has a color different from the underlying color of the outside surface of the tube and is removed at least partially at one or more regions thereof when the indicator device is exposed to anaerobic soil conditions over time such that the indicator device changes color at said one or more regions as a result of at least partial removal of said coating. The indicator device is removed from the soil for visual inspection to determine the location of its color change. The depth of the water table is indicated by the location (length) of the color change on the tubular member. The indicator coating is not removed when the device is exposed to aerobic soil conditions.

In further illustrative embodiments of the invention, the tubular member comprises a PVC (polyvinyl chloride) tube having the microorganism energy source disposed on the inside of the tubular member and having on the outside surface of the tube a coating of iron oxides, such as for example, ferrihydrite. When the indicator device is installed in the soil, the energy source is released from openings provided in the tubular member to the soil to initiate anaerobic microbial activity in the soil proximate the indicator device. The oxide indicator coating will be removed at least partially through its thickness at one or more regions by virtue of the reducing conditions present in the soil and ultimately may expose the underlying white PVC substrate, thereby providing a visual indicator in the field of the depth of the water table at the test location.

Advantages and features of the present invention will become more readily apparent from the following detailed description taken with the following drawings.

### DESCRIPTION OF THE DRAWINGS

FIG. 1A is an elevational view of an indicator device before placement in the soil and after drilling of openings in the sidewall of the device for release of an energy source therein for anaerobic microogansims into the soil.

FIG. 1B is a representation of an indicator device of the invention after placement in the soil source under anaerobic conditions and upon removal from the soil for visual inspection.

### DESCRIPTION OF THE INVENTION

Pursuant to an illustrative embodiment of the invention, an indicator device comprises an indicator member 10 adapted to be placed in the soil and an energy source 100 for anaerobic microorganisms for release into the soil proximate the indicator member 10 to initiate anaerobic activity in the soil. The energy source 100 can be disposed in or on the indicator member 10, or separate therefrom yet operably associated with the indicator member in a manner that releases the energy source into the soil proximate the indicator member to initiate anaerobic activity. For example, the energy source can comprise a separate porous sleeve in, on, or separate from the indicator member and coated and/or impregnated with the energy source 100 for releasing the energy source into the soil proximate the indicator member.

In a particular illustrative embodiment of the invention, the indicator member 10 preferably comprises an elongated PVC (polyvinyl chloride) tubular member 10a, although other shapes and materials can be used for the indicator member. The tubular member can have a length of 12 inches to 10 feet and an inner/outer diameters of ½ inch to ⅞ inch, although other lengths and inner/outer diameters can be used in practice of the invention.

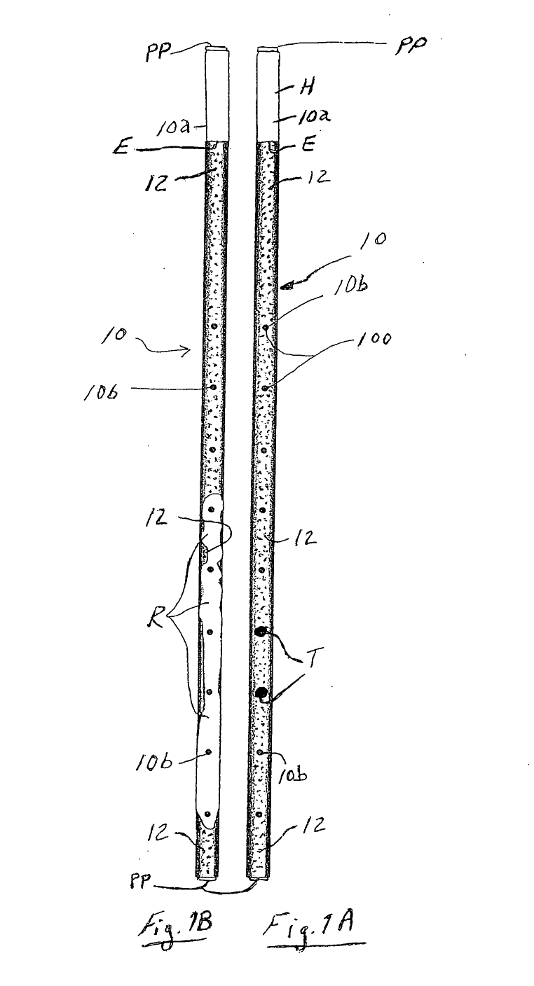

The indicator member is coated with an indicator coating 12 (represented as speckled coating), FIG. 1A, that is at least partially removed through its thickness at one or more coating regions R, FIG. 1B, when the indicator device is exposed in the soil to anaerobic conditions over time. The indicator device thereby changes color at the one or more regions R from the color of the original indicator coating. The visual indicator coating is not removed when the device is exposed to aerobic soil conditions over time. An indicator coating useful in practice of the invention comprises a metal oxide, such as for example an iron oxide coating comprising ferrihydrite, goethite, lepidocrocite, and/or hematite, a manganese oxide such as for example, birnessite, and other metal oxides and compounds that will be removed from the substrate by exposure to anaerobic soil conditions over time to cause a change in color of the indicator device. An indicator coating thickness can be about 0.001 inch or less, although other coating thicknesses can be used.

An uncoated upper region of the tubular member 10 forms a handle H for manipulation of the indicator device 10.

An illustrative tubular indicator member 10a comprises white PVC tubing having a variegated reddish brown and yellow iron oxide coating 12 thereon where the coating preferably includes ferrihydrite. Ferrihydrite is an iron-containing mineral that is common in many soils and is relatively insoluble in soil solutions that have free access to oxygen. When exposed to sustained anaerobic soil conditions, the thickness of a ferrihydrite coating is dissolved at least partially at one or more coating regions in the soil solution, thereby providing a visual indication that in the field reducing hydric soil conditions were present. Each iron oxide coated PVC tube is inserted in a hole in the soil that is approximately the same diameter as the tube diameter. In a few weeks or months, the tubes are pulled out and examined. In freely drained aerobic soils the iron oxide coating is not dissolved, even though much water leaches through the soil and it is saturated for short periods of time (e.g. less than two weeks), and the rods retain their reddish brown color. If however, the soil becomes saturated with water for a longer time, and the soil solution becomes anaerobic (depleted of oxygen), iron is reduced (Fe⁺³→Fe⁺²), iron oxide dissolves, and portions or regions R or all of the indicator device become(s) yellowish from partial dissolution of the coating thickness or possibly become(s) white (the color of the PVC tube 10) when there is complete removal of the coating to expose the white PVC tube. The whiter the indicator device, the more the reduction that has occurred in the soil. Qualitative evaluations can be made by comparing the colors on the indicator device surface with the color of those that were never installed in the soil and with a standard color chart. The surface area of altered iron oxide coating can be estimated or measured. Quantitative measurements can be made by photographing the indicator devices and analyzing the color and the surface area using computer software. Thus, when the iron oxide coated tubes are installed in anaerobic soils that are saturated and reduced for a short time, some of the coating is dissolved as a result of microbial activity, thereby providing a visual indicator in the field that reducing conditions were present.

The tubular indicator member 10a includes an energy source 100 therein for anaerobic microorganisms for release from inside the tubular member through spaced apart openings 10b in the cylindrical sidewall of the tubular member 10a into the soil outside and proximate the indicator member 10a to initiate anaerobic activity in the soil. The openings 10b are drilled at a test site to release the energy source once the indicator device is placed in the soil. In an alternative embodiment, the openings 10b can be drilled at the manufacturing facility and sealed with tape or plug closures T (two sealing closures T shown in FIG. 1A for illustration) on the tubular member, before filling of the tubular member with the agar/sugar solution followed by removal of the sealing tape or plug closures T at the test site before placing the tubular member in the soil to allow release of the energy source 100 into the soil outside the and proximate the indicator member 10a to initiate anaerobic activity in the soil.

The energy source 100 can comprises an agar/sugar solution introduced into the inside of the tubular indicator member 10a before the device 10 is shipped to a test site, although other energy sources such as including, but not limited to, other sugars, alcohols, amino acids, formate, acetate, butyrate, propionate, long chain fatty acids, and aromatic compounds can be used depending upon the anaerobic microorganisms to be activated. For purposes of illustration and not limitation, the agar/sugar solution comprises an agar medium in the amount of 40 gram/liter of distilled water and sugar in the amount of 25 grams/liter of distilled water. This agar/sugar solution is poured into the open top end of the tubular indicator member 10a during manufacture of the indicator device, the bottom end of the tubular member 10a being closed by a plug (e.g. dowel) PP adhered or otherwise fastened in the bottom tube end with the openings 10b being sealed closed by tape or plug closures T also if they are drilled at the manufacturing facility. After the agar/sugar solution is introduced into the tubular member, the top end is closed by a similar plug (dowel) PP adhered or otherwise fastened in the top end. The indicator device then is ready for shipping to a test site. The agar/sugar solution is introduced into the tubular member to fill it to about 12 inches below the top of the tubular member.

Once at a test site, the openings 10b are drilled in the tubular member which is then placed in the soil as described below with the top end and bottom end remaining closed by the plugs PP therein. Or, in the alternative embodiment, the openings 10b are opened by removing the tape or plug closures T if they have been pre-drilled and sealed at the manufacturing facility and then the tubular member is placed in the soil as described below with the top end and bottom end remaining closed by the plugs therein PP. The tubular indicator member is then placed in the soil as described below with the top end and bottom end remaining closed by the plugs therein. The openings 10b in the tubular member preferably are sized as weep holes (e.g. 3/32 inch hole diameter) to gradually release the energy source by dispersion and advection of the dissolved compounds into the saturated soil. The openings 10b can be spaced apart along the length of the tubular member as well as around its circumference in order to release the energy source along a preselected depth and volume of the soil. In an illustrative embodiment of the invention, pairs of diametrically opposite openings 10b can be drilled in the tubular member at the test site (or at the manufacturing facility) using a drill bit that penetrates from one side to the other opposite side of the tubular member. When the tubular member is placed in the soil, the openings 10b provide weep holes for release of the agar/sugar solution into the surrounding soil.

For purposes of illustration and not limitation for use in connection with the agar/sugar solution to determine depth of the water table (the groundwater surface where the groundwater pressure is equal to atmospheric pressure) at a test location. Nine (9) pairs of openings 10b are drilled at the test site on opposite sides of the tubular member 10b beginning 12 inches below the top edge E of the oxide indicator coating to provide a total of 18 openings 10b. The openings 10b have a diameter of 3/32 inch and are spaced apart by 4 inches along the length of the tubular member and by 180 degrees around the tube circumference. The length of the tubular indicator member 10a can be 54 inches with the oxide indicator coating 12 applied on the lower 48 inches of length of the tubular member, leaving 6 inches of the tubular member uncoated as a handle. The tubular member 10a is coated with the oxide indicator coating as described in U.S. Pat. No. 6,766,762, the teachings of which are incorporated herein by reference.

For testing to determine depth of the water table at a test site or location pursuant to a method embodiment of the invention, the coated tubular indicator member 10a is drilled to provide the weep openings 10b in the sidewall and then is inserted in a hole in the soil that is approximately the same diameter as the tube diameter with the uncoated handle above ground. The agar/sugar solution is released gradually over time through the drilled openings 10b into the soil around the tubular member to initiate anaerobic microorganism activity. The anaerobic activity occurs in the soil profile where the water table resides. In a few weeks or months, the tubular member is pulled out and examined. At the water table, the soil becomes anaerobic (depleted of oxygen), iron is reduced (Fe⁺³→Fe⁺²), the iron oxide coating dissolves, and portions or regions R or all of the indicator device become(s) yellowish from partial dissolution of the coating thickness or possibly become(s) white (the color of the PVC tube 10) when there is complete removal of the coating to expose the white PVC tube. The water table depth is indicated by the depth (length) of the reduction (color change) on the outside surface of the tubular member.

Although the invention has been described with respect to certain embodiments thereof, those skilled in the art will appreciate that the invention is not so limited and various changes, modifications and the like can be made therein without departing from the spirit and scope of the invention as set forth in the appended claims.

I claim:

1. An indicator device, comprising an indicator member adapted to be disposed in soil and having an indicator coating which is removed at least partially removed at one or more regions thereof when the indicator member is exposed to anaerobic conditions over time, and an energy source for anaerobic microorganisms for release into the soil proximate the indicator member to initiate anaerobic activity in the soil.

2. The device of claim 1 wherein said indicator device changes color at said one or more regions as a result of at least partial removal of said coating under the anaerobic conditions.

3. The device of claim 1 wherein the energy source is disposed inside the indicator member and released from inside the indicator device to soil outside the indicator device.

4. An indicator device adapted to be disposed in soil, comprising a tubular member having an energy source for anaerobic microorganisms disposed in the tubular member for release into the soil through one or more openings in the tubular member to initiate anaerobic activity therein and an indicator coating on the outside surface of the tube, wherein the indicator coating is removed at least partially at one or more regions thereof when the indicator device is exposed to anaerobic conditions over time, said indicator device changing color at said one or more regions as a result of at least partial removal of said coating.

5. The device of claim 4 wherein the tubular member includes a plurality of openings spaced apart along its length that is placed in the soil.

6. The device of claim 5 wherein the openings are sized to allow the energy source to seep to the soil over time.

7. The device of claim 4 wherein the energy source comprises agar and sugar.

8. The device of claim 4 wherein the indicator coating is a metal oxide.

9. The device of claim 8 wherein said metal oxide comprises iron oxide.

10. The device of claim 9 wherein said iron oxide comprises ferrihydrite.

11. The device of claim 4 wherein said tubular member comprises an elongated plastic tube having a white color.

12. The device of claim 4 wherein said indicator coating has a thickness of about 0.001 inch or less.

13. An indicator device adapted to be disposed in soil, comprising a tubular member having an energy source for anaerobic microorganisms disposed in the tubular member for release into the soil through one or more openings in the tubular member to initiate anaerobic activity therein and an indicator coating on the outside surface of the tube, closures on the tubular member for closing the openings until the tubular member is placed in the soil, wherein the indicator coating is removed at least partially at one or more regions thereof when the indicator device is exposed to anaerobic conditions over time, said indicator device changing color at said one or more regions as a result of at least partial removal of said coating.

14. A method of determining depth of the water table at a soil location, comprising placing in the soil an indicator member having an indicator coating thereon that is at least partially removable at one or more regions thereof when the indicator device is exposed to anaerobic soil conditions over time so that the indicator device changes color at said one or more regions as a result of at least partial removal of said coating, releasing an energy source for anaerobic microorganisms into the soil proximate the indicator member, and removing the indicator member from the soil after a time period for inspection, wherein the depth of the water table is indicated by the location of said color change.

15. The method of claim 14 wherein the energy source is released from inside a tubular indicator member through openings in the side wall of the tubular member.
